(19) United States
(12) Patent Application Publication
(10) Pub. No.: US 2005/0146744 A1
(43) Pub. Date: Jul. 7, 2005

(54) Mobile-device print system and methods for remote printing

(76) Inventors: Timothy McAllister, Vancouver, WA (US); John L. Manuel, Camas, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/752,973

(22) Filed: Jan. 7, 2004

(51) Int. Cl. G06F 15/00

(52) U.S. Cl. 358/1.15

(57) ABSTRACT

A method for enabling remote printing from a wireless mobile-communication device includes generating a print job request responsive to a user directed selection of one of a plurality of print command paths, directing the print job request to one of the plurality of print command paths in response to the user directed selection, and wirelessly communicating information from the mobile-communication device to a remote device to complete the print job.

### BACKGROUND

Portable devices that link users to communication services are popular and widespread. Personal digital assistants (PDAs) include pocket-personal computers with a range of computing capabilities. Cellular telephones are commercially available with more and more functionality that until recently has been provided by computing devices interconnected using wired communication links. For example, cellular telephone service providers now provide email services, paging, and a host of other information services.

One of the driving forces behind the popularity of mobile-communication devices is the ability to interact with devices coupled to the Internet and other networks from anywhere within the reach of a wireless-communication service provider. Wireless-communication links allow the operator of a mobile-computing device and/or a mobile-communication device to access data and devices coupled to networks accessible through the wireless-communication service provider. For example, a cellular telephone user can access information via the Internet or a PDA user can locate, access, and retrieve files from a remote-office LAN, in addition to accessing the Internet and other networks.

Users of mobile-communication devices need an application program generally called a “browser” and a communication link to the Internet to access a web site. Browsers are software applications that locate, request, receive, and display content stored within a specific device coupled to the Internet. Popular browsers for laptop and desktop-computing devices are graphical browsers. Graphical browsers display graphics including text. Browsers for mobile-communication devices generally display text information, although more recent communication services provide some graphics and sound.

Web browsers also enable a user to navigate the Internet, i.e., view HTML files stored on a web-connected device, view data stored on another network, or access data stored on a user's computing device or the user's mobile-communication device. A user can navigate the Internet by entering a URL in an address-entry field provided by the browser or selecting a “link” embedded in a displayed representation of an HTML file. A user can navigate network-coupled devices by entering appropriate paths in the address-entry field. Once the user has found a folder or file-of-interest, the user can enter a command to view the contents of the folder or open the file-of-interest. When the file-of-interest is a HTML file, the browser displays the file like any other web page. Since mobile-communication devices often are not equipped to store and run robust applications, the representation of the downloaded or otherwise identified HTML file is often limited to text.

A user of a mobile-communication device can download a web page or access other information by locating an associated file stored on a device connected to the web. The user can then initiate a print job to create a hard copy of the web page. For example, existing PDAs generally enable printing from the PDA to a printer using a wireless link. However, methods for enabling mobile-communication devices to print a file are problematic. While some problems have been addressed in part, conventional solutions do not provide a comprehensive solution accessible by any application operable on a given mobile device.

For example, the Pocket PC® does not provide a print solution accessible to all applications programmed for the device. The Pocket PC® operating system is based on Windows CE®. While Windows CE® provides a print mechanism, this mechanism is not used by the Pocket PC® operating system. Windows CE® is the registered trademark of the Microsoft Corporation of Redmond, Wash., U.S.A. Pocket PC® is the registered trademark of Thaddeus Computing Inc., Fairfield, Iowa, U.S.A. Consequently, programmers of applications directed to the Pocket PC® do not have access to a print mechanism for directing a printer to create a hard copy of information.

The print mechanism available in Windows CE® resembles the known desktop-printing model found in the other Windows® operating systems. Windows® is a registered trademark of the Microsoft Corporation. This desktop-printing model is not well suited to mobile-communication devices as it is difficult to implement, does not provide access to service-based printing, and requires a separate driver for each printer model that the operator might encounter.

Known mobile-computing device print mechanisms provide print capabilities integrated with a single application. The various print mechanisms embedded within the applications do not provide connectivity with emerging print services. Thus, the print mechanisms are somewhat limited and cannot be used by application developers to print enable other applications intended for the mobile-communication and mobile-computing devices.

Field Software Products produces a printing application “Print Pocket CE.” Print Pocket CE is a printing application for the Pocket PC® operating system. Because Print Pocket CE is an application and not a print sub-system, Print Pocket PC cannot be used by other applications on a mobile device. In addition, Print Pocket PC does not provide Print Service Interface (PSI) capabilities. The PSI is an open source standard managed by the Printer Working Group. See http://www.PWG.org/ps for information about the PSI.

Bachmann Software & Services, LLC produces a product called “PrintBoy.” Bachmann's solution is similar to Print Pocket PC in that it is not intended to print enable other applications, nor does it have PSI print capabilities. ATSONIC offers a product called “sweetPRINT.” Like the others mentioned above, it offers file browsing capabilities and forwards documents to a fax machine for reproduction. SweetPRINT does not interface with a printer and like the other products does not work with the PSI print service.

Consequently, improved systems and methods are desired to print enable a mobile-communication device.

### SUMMARY

An embodiment of a method for remote printing from a wireless mobile-communication device includes generating a print job request responsive to a user directed selection of one of a plurality of print command paths, directing the print job request to one of the plurality of print command paths in response to the user directed selection, and wirelessly communicating information from the mobile-communication device to a remote device to complete the print job.

### BRIEF DESCRIPTION OF THE DRAWINGS

Embodiments of a mobile device print system methods for remote printing are illustrated by way of example and not limited by the implementations depicted in the following drawings. The components in the drawings are not necessarily to scale. Emphasis instead is placed upon clearly illustrating the principles of the print system and printing methods. Moreover, in the drawings, like reference numerals designate corresponding parts throughout the several views.

FIG. 1 is a schematic diagram illustrating an embodiment of a mobile device.

FIG. 2 is a functional block diagram illustrating the operation of an embodiment of a print system that can be provided within the mobile device of FIG. 1.

FIG. 3 is a flow diagram illustrating an embodiment of a method for enabling remote printing from the mobile device of FIG. 1.

FIG. 4 is a flow diagram illustrating an embodiment of an alternative method for printing from the mobile device of FIG. 1.

### DETAILED DESCRIPTION

A mobile device includes a print system that enables an operator of the mobile device to communicate with a host of remote devices via one or more wireless links to print information. Any of a number of wireless-communication protocols can be used to transmit information to the remote devices. The following examples include the I.E.E.E. 802.11 protocols, Bluetooth, and infrared-data association protocol (IrDA), although the print system can be coupled to remote devices using other now known or later developed wireless protocols.

The print system provides a generic solution that can be shared by applications on the mobile device. Software developers can use the print system to add print capabilities to their applications without the need for additional resources. The print system uses a number of logical components across a plurality of distinct processing paths to provide connectivity to print services as well as connectivity to printers configured to communicate via a select wireless communication protocol or via a network-coupled device. Print services are network-coupled logical units that provide a host of printing capabilities to computing devices that can access the network. A print service can be addressed or otherwise communicated with using the Transmission Control Protocol/Internet Protocol (TCP/IP)-Hypertext Transfer Protocol (HTTP)-EXtensible Markup Language (XML)-Simple Object Access Protocol (SOAP) communication protocol stack to perform a multitude of parallel tasks.

The name TCP/IP refers to an entire suite of data communications protocols. Originally known as “Internet protocol suite,” the entire are known as TCP/IP from two of the most popular protocols which belong to the suite of protocols: Transmission Control Protocol (TCP) and the Internet Protocol (IP). HTTP is the protocol used on the publicly accessible Internet or across proprietary networks for sending web pages to users. XML is similar to the language of today's Web pages, HTML. Both XML and HTML contain markup symbols to describe the contents of a page or file. HTML, however, describes the content of a Web page only in terms of how it is to be displayed and interacted with while XML describes the content in terms of what data is being described. An XML file can be processed purely as data by a program or it can be stored with similar data on another computer or, like an HTML file, it can be displayed. XML is “extensible” because, unlike HTML, the markup symbols are unlimited and self-defining. XML is actually a simpler and easier-to-use subset of the Standard Generalized Markup Language (SGML), the standard for how to create a document structure.

SOAP is an XML-based object invocation protocol. SOAP was originally developed for distributed applications to communicate over HTTP and through corporate firewalls. SOAP is a wire protocol that can be used to facilitate an ultra-distributed architecture. SOAP is a protocol that defines how to access services, objects, and servers in a platform-independent manner using HTTP and XML.

For example, a print service can be preloaded with a set of drivers or other software corresponding to each printing device coupled to a local area network (LAN) where the print service is hosted. The print service translates generic print commands generated by the mobile device to printer-ready data that is used by the printer to generate a hard copy representation of information stored within the mobile device.

In one mode of operation, the mobile device sends “metadata” about a document or content that an operator of the mobile device desires to have printed. That is, the mobile device sends an electronic copy of the document intended to be printed—for example a PDF file—and the print service is responsible for converting the PDF file into printer ready bits. The mobile device forwards generic print commands along with the metadata. Generic print commands may include information identifying a particular printer, the number of copies desired, a desired print quality, etc.

In another mode of operation, the print service generates a request for accessible content. After the accessible content is received by the print service, the print service uses an appropriate driver or other software to translate the content into printer-ready data that the print service forwards to the printer. In a third mode of operation, the print service locates, retrieves, images, and renders data stored in a network-coupled data store.

At least one of the plurality of processing paths is configured to communicate with print services. These print services can be print service interface (PSI) compliant services or other non-PSI compliant services. The PSI is an open standards collective effort managed by the Printer Working Group. See http://www.PWG.org/ps for additional information regarding the PSI. Regardless of the information source or type of print service, print services, when used, perform some portion of the tasks necessary to generate printer-ready data for a select printer.

The print system can be used to direct and control a printer to print information stored in a variety of document types across a variety of locations. For example, the print service can be configured with a host of application software, thus enabling the print service to offload communication, imaging, and rendering tasks associated with printing *.doc, *.xls, *.pdf, *.jpg, *.html, and other file types.

Another of the plurality of processing paths is configured to bypass a print service. This more direct processing path receives information to be printed, translates the information to an intermediate representation, and uses the intermediate representation to generate printer-ready data which is then forwarded to the wireless interface for communication to a select printer or a wireless-access point communicatively coupled to a select printer.

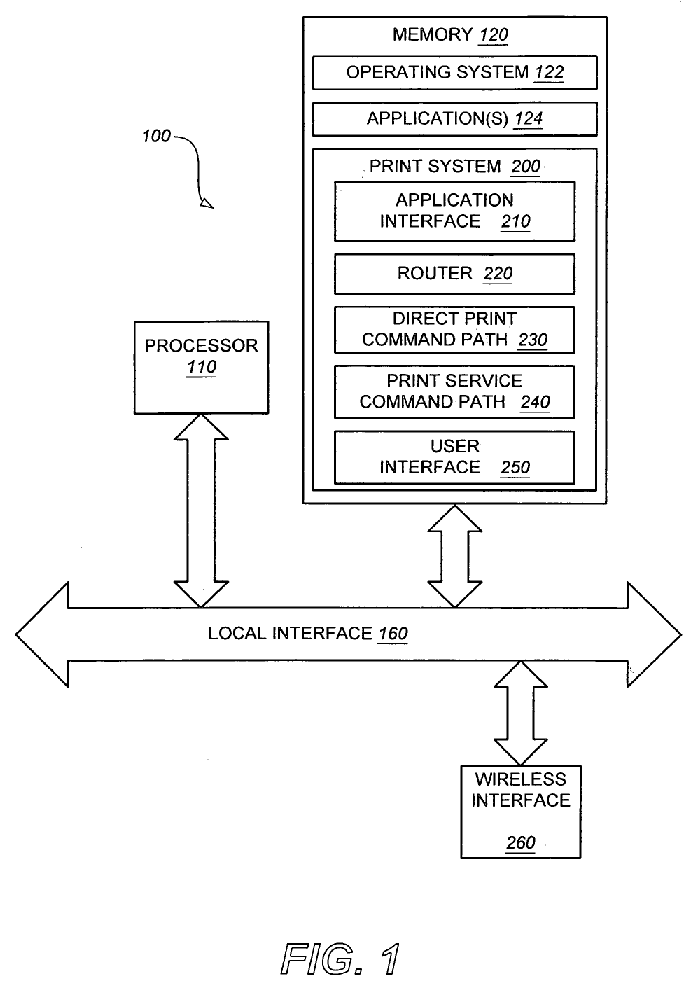

Turning now to the drawings, reference is made to FIG. 1, which illustrates a functional block diagram of a mobile device 100. Generally, in terms of hardware architecture, as shown in FIG. 1, mobile device 100 includes a processor 110, memory 120, and a wireless interface 260 that are communicatively coupled via local interface 160. The local interface 160 can be, for example but not limited to, one or more buses or other wired or wireless connections, as known in the art or that may be later developed. Local interface 160 may have additional elements, which are omitted for simplicity, such as controllers, buffers (caches), drivers, repeaters, and receivers, to enable communications. Further, local interface 160 may include address, control, and/or data connections to enable appropriate communications among the aforementioned components.

In the embodiment, of FIG. 1, the processor 110 is a hardware device for executing software that can be stored in memory 120. The processor 110 can be any custom-made or commercially available processor, a central processing unit (CPU) or an auxiliary processor among several processors associated with the mobile device 100. In some embodiments, processor 110 is a semiconductor-based microprocessor (i.e., a microchip) or an application-specific integrated circuit (ASIC).

Memory 120 includes any one or a combination of volatile memory elements (e.g., random access memory (RAM, such as dynamic RAM or DRAM, static RAM or SRAM, etc.)) and nonvolatile memory elements (e.g., read-only memory (ROM). Moreover, the memory 120 may incorporate electronic, magnetic, optical, and/or other types of storage media now known or later developed. Note that memory 120 can have a distributed architecture, where various components are situated remote from one another, but accessible by processor 110.

The software in memory 120 may include one or more separate programs, each of which comprises an ordered listing of executable instructions for implementing logical functions. In the example of FIG. 1, software in memory 120 includes an operating system 122, one or more application(s) 124, and a print system 200. Application(s) 124 and print system 200 function as a result of and in accordance with operating system 122. Operating system 122 controls the execution of the other application(s) 124 and computer programs, such as print system 200, and provides scheduling, input-output control, file and data management, memory management, and communication control and related services.

Print system 200 and application(s) 124 include one or more source programs, executable programs (object code), scripts, or other collections each comprising a set of instructions to be performed. As will be explained in detail below, print system 200 includes logic that interacts with application(s) 124. More specifically, print system 200 includes logic that controls the execution of an application interface 210, router 220, direct print command path 230, print service command path 240, and user interface 250 to dynamically communicate with one or more remote devices to complete a print task. It should be well understood by one skilled in the art, after having become familiar with the print system 200, that print system 200 and application(s) 124 may be written in a number of programming languages now known or later developed. Moreover, print system 200 and application(s) 124 may be stored across distributed memory elements in contrast with the single memory element (i.e., memory 120) shown in FIG. 1.

Wireless interface 260 includes a host of devices that establish one or more communication sessions between mobile device 100 and one or more local and/or wide area networks (not shown). Wireless interface 260 may include but is not limited to, a modulator/demodulator or modem (for accessing another device, system, or network); a radio frequency (RF) or other transceiver such as those provided in a cellular telephone; an infra-red (IR) (i.e., an optical) interface such as those provided in a laptop computer or a PDA; etc. For simplicity of illustration and explanation, these two-way communication devices are not shown.

Mobile device 100 communicates with one or more network coupled devices via wireless-communication links (not shown). As explained above, the wireless-communication links can be IR or radio-frequency (RF) links capable of transferring alphanumeric strings from mobile device 100 to receiving devices. A variety of wireless interfaces and data-transfer protocols support the communication of alphanumeric information from a portable device such as mobile device 100 and an appropriately configured receiving device. For example, infrared-data association protocol (IrDA), wireless fidelity (IEEE 802.11b wireless networking) or Wi-Fi, Bluetooth®, etc. each support wireless-data transfers. Bluetooth® is the registered trademark of Bluetooth SIG, Inc.

Bluetooth® is particularly useful for data transfers between mobile device 100 and appropriately configured printers, computers, LAN interfaces, and Internet-service provider (ISP) wireless-access points. Bluetooth® uses a number of RF channels between 2.40 and 2.48 GHz to communicate data. Since Bluetooth® uses a RF transmission medium, communicating devices do not need to be in the line-of-sight (LOS) of each other's IR beam. Bluetooth® also frequency hops, i.e., Bluetooth® changes frequencies over a thousand times a second using nearly eighty channels within the 2.40 and 2.48 GHz frequency range. Consequently, even though Bluetooth® shares this frequency range with cordless phones, baby monitors, and 802.11b wireless networks, data transmission disruptions are negligible.

Perhaps the most significant feature of Bluetooth® technology that makes it well-suited for mobile device 100 is that Bluetooth®-enabled devices can find and establish a communication link with each other without the user having to initiate the link. When two Bluetooth®-enabled devices come within signal range of each other, they immediately begin a series of negotiations to determine if they have information for one another. If the negotiation session results in a determination that the devices have information for one another, the devices form a piconet or a personal-area network. Consequently a Bluetooth®-enabled mobile device 100 can automatically establish communication links with Bluetooth®-enabled printers (not shown). A Bluetooth®-enabled mobile device 100 can also establish communication links with Bluetooth®-enabled printers in accordance with operator directed commands. Furthermore, Bluetooth®-enabled devices rely on a set of rules or profiles for communicating particular types of data. Typical profiles, include a serial-port profile for communicating printer-ready data and or otherwise connecting devices such as printers and scanners. Bluetooth® also includes an object-push profile for moving data between devices, a synchronization profile for PDA-synch operations, a facsimile profile, which allows a personal computer (PC) to use a Bluetooth®-enabled cellular phone as a facsimile modem.

While Bluetooth®-enabled devices have been described above in association with the schematic of FIG. 1, those of ordinary skill in the art will understand that wireless-data transfer protocols IrDA, 802.11 (a), 802.11 (b), etc. are also capable of establishing a communication link capable of communicating with remote devices.

As further illustrated in FIG. 1, print system 200 includes an interface 210, a router 220, a direct print command path 230, a print service command path 240, and user interface 250. Application interface 210 receives operational parameters that identify a select printer, information to be printed, and one of the direct print command path 230 or print service command path 240 to communicate with one or more remote devices to generate a hard copy product. Router 220 directs the received operational parameters in accordance with an operator selection of one of the direct print command path 230 or the print service command path 240. When use of the direct command path 230 is indicated, router 220 forwards a print job request received from interface 210 for internal processing along the direct command path 230.

In accordance with a desired printer identified in the print job request, the direct command path 230 processes information to be printed thus generating printer-ready data that is forwarded to the select printer via wireless interface 260. For example, when the select printer is a printer such as a Hewlett-Packard DeskJet® 995c printer, which includes a Bluetooth® wireless interface, information identifying the printer and its capabilities can be communicated to mobile device 100. The print system 200 can then search for a best-match driver to support the DeskJet® 995c model printer. DeskJet® is the registered trademark of the Hewlett-Packard Company of Palo Alto, Calif., U.S.A.

It is often the case that mobile device 100 is not entirely configured to operate the select printer. For example, when the mobile device 100 is a mobile-computing device that an operator on a business trip desires to use to print a document from a printer coupled to a business associate's network. Generally, to print information stored or otherwise accessible via the mobile-computing device, the operator has to locate and identify a select printer available on the network. After identifying the select printer, many applications 124 require a printer specific device driver before the application(s) 124 can print information on the printer. As explained in further detail below, print system 200 can be used to identify and use an available print service. An available print service is any print service open to an operator of the mobile device 100 that is communicatively coupled to a device within communication range of the mobile device 100. The print service applies a suitable device driver or other software to render data on the select printer. In these circumstances, i.e., when the print job request indicates that a print service will be used to process and complete the desired print task, the print job request is forwarded by the router 220 to the print service command path 240.

Modules within the print service command path 240 process the print job request such that the request is compliant with requests designated for the desired print service. When the desired print service is a PSI compliant print service, the print job request will comprise SOAP messages and calls to print methods exposed through the PSI interface. The print service command path 240 will further monitor print task progress using information provided by the remote print service.

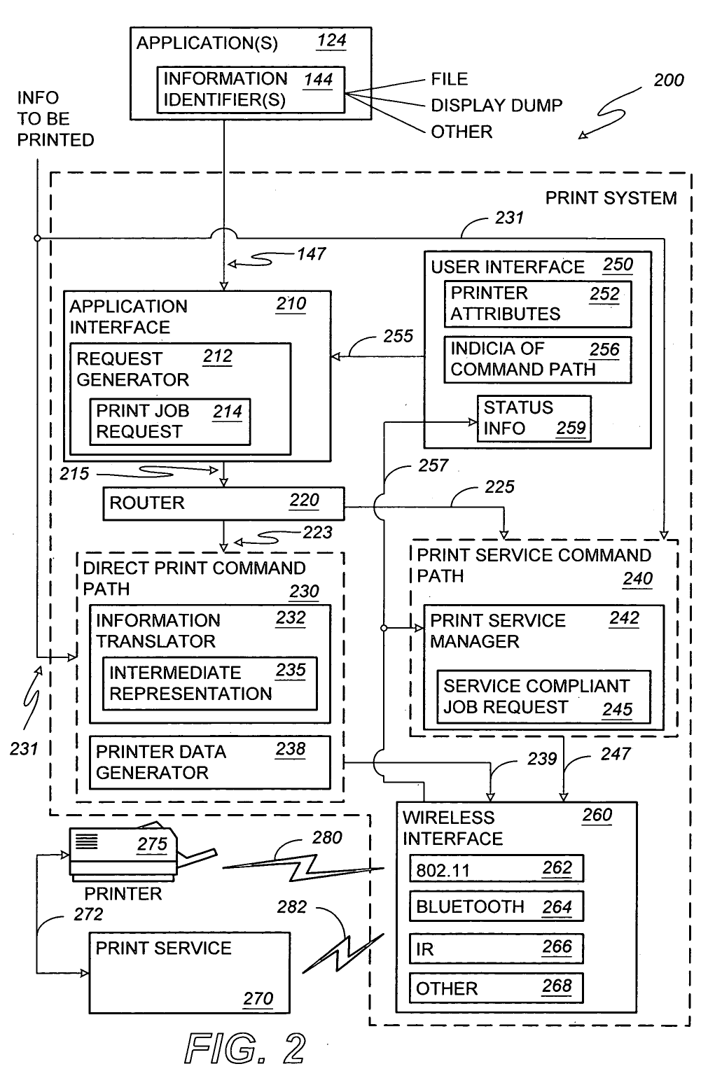

User interface 250 enables an operator of the mobile device 100 to selectively choose between a plurality of command paths available within the mobile device 100. As will be explained in further detail along with the description of FIG. 2, an operator of mobile device 100 initiates a print task using an application 124 operable on the mobile device 100. The application 124 forwards information identifying content to be printed. Print system 200 uses the identifying information to provide an indication via user interface 250 which of the plurality of command paths has access to the necessary resources to print the content.

User interface 250 can be a graphical-user interface in conjunction with pressure-sensitive pushbuttons that correspond to various alphanumeric characters or functions to enable an operator of the mobile device 100 to communicate the various parameters and other information. The user interface 250 can also include one or more input devices to navigate various menus presented on a display associated with the mobile device 100. User interface 250 can include an icon or other representation of each printer or other hard copy device that can be accessed and used to print the content. User interface 250 further distinguishes between accessible printers by grouping the representations under the command paths that can be used to communicate with the various printers.

It should be understood that print system 200 can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. A “computer-readable medium” can be any methods and resources for storing, communicating, propagating, or transporting a program for use by or in connection with the instruction execution system, apparatus, or device. The computer-readable medium can be, for example but not limited to, an electronic, magnetic, optical, electromagnetic, infrared, or semiconductor system, apparatus, device, or propagation medium now known or later developed. Note that the computer-readable medium could even be paper or another suitable medium upon which the program is printed, as the program can be electronically captured, via for instance optical scanning of the paper or other medium, then compiled, interpreted, or otherwise processed in a suitable manner if necessary, and then stored in a computer memory.

Print system 200 can be implemented in hardware, software, firmware, or combinations thereof. In a preferred embodiment, print system 200 is implemented using software that is stored in memory 120 and executed by a suitable instruction execution system. If implemented solely in hardware, as in an alternative embodiment, print system 200 can be implemented with any or a combination of technologies well-known in the art (e.g., discrete logic circuits, application specific integrated circuits (ASICs), programmable gate arrays (PGAs), field programmable gate arrays (FPGAs), etc.), or technologies later developed.

In one embodiment, the print system 200 is implemented via a combination of software and data. The software is stored in memory 120 and executed and buffered or otherwise processed under the control of processor 110 within mobile device 100. It should be noted, however, that print system 200 is not dependent upon the nature of the underlying processor 110 or memory 120 in order to accomplish designated functions.

Reference is now directed to FIG. 2 which presents a functional block diagram illustrating operation of the print system 200 introduced in FIG. 1. As illustrated in FIG. 2, application(s) 124 provide information identifier(s) 144 via link 147 to print system application interface 210. Upon receipt of the information identifier(s) 144, user interface 250 is enabled and presents an operator of mobile device 100 with some indication of the available print resources and command paths that can be used to generate a hard copy of the data referenced or otherwise described by the information identifier(s) 144. As described above, user interface 250 may present a representation of both available printers and possible command paths to an operator of the mobile device 100. After receiving a selection from the operator of the desired printer, user interface 250 forwards printer attributes 252 and an indicia of (the selected) command path 256 to application interface 210 via link 255. The user interface 250 forwards additional information (not shown) used by the select command path to direct a remote print service or printer to complete an operator desired print task. This additional information may comprise an indication of how many copies are desired, a paper size and orientation, a desired print quality, etc. This additional information will vary with the capabilities of each printer resource available with the select printer. The additional information is also communicated to application interface 210 via link 255.

Information identifier(s) 144 include a file name, a file type or extension, a directory path in combination with a file name, or other mechanisms that designate information desired to be printed on the select printer. In some circumstances, the information desired to be printed may be already rendered on a display device such as the display associated with the mobile device 100. Under these circumstances information identifier(s) can include an alphanumeric string indicating the type of data to follow and a representation of the rendered data.

Indicia of (a select) command path 256 is any information that can be used to identify an operator's desired method for communicating with one or more remote devices to complete the print task. For example, indicia of command path 256 can be a one bit flag, a label, or other encoding that can be interpreted by router 220 as directing the use of one of the direct print command path 230 or the print service command path 240.

Application interface 210 processes the information identifier(s) 144, printer attributes 252, indicia of command path 256 and additional information in request generator 212 which formats the received information into print job request 214. Print job request 214 is applied to router 220 via link 215. Router 220 uses the indicia of (the select) command path 256 to determine which of links 223 and 225 is the desired link for forwarding print job request 214. When the indicia of (the select) command path 256 indicates that the mobile device 100 is to process the print job request 214, the print job request 214 is forwarded by router 220 along link 223 to the direct print command path 230. Otherwise, when the indicia of (the select) command path 256 indicates that a print service is to be used to process the print job request 214, the print job request 214 is forwarded by router 220 along link 225 to the print service command path 240.

Direct print command path 230 receives the print job request 214 via link 223 and information or the actual content/file to be printed via link 231. Information translator 232 receives the print job request 214 and the information to be printed as defined or otherwise identified by the information identifier(s) 144 and transforms the content in accordance with the select printer to an intermediate representation 235. The intermediate representation 235 includes information from which printer-ready data can be generated. For example, the information translator 232 would transform a file stored in the graphics interchange format (GIF), a common file format for graphics images on the World Wide Web, to 24-bit red, green, blue (RGB) data. Colored images are often stored as a sequence of RGB triplets or as separate red, green, and blue overlays, though this is not the only possible representation (see CMYK or cyan, magenta, yellow and black, the standard colors used for printed output or HSV a color model that uses hue, saturation, and a value in a cylindrical color coordinate system.) These colors correspond to the three “guns” in a color cathode-ray tube and to the color receptors in the human eye. In another example, information translator 232 would transform a file stored in the rich text format (RTF), a file format that enables the exchange of text files between different word processors in different operating systems, to 24-bit RGB data. Other possible intermediate representations 235 would largely be dictated by the capabilities of printer data generator 238.

In the example illustrated in FIG. 2, printer data generator 238 includes an imaging pipeline to, create optimized printer specific data. An imaging pipeline includes color matching, half-toning, scaling, etc. to further convert the information desired to be printed into printer-ready data optimized for the select printer. In some embodiments, printer data generator 238 can be implemented using an appliance printing development kit (APDK) or other similar kits. The APDK is a software development kit that enables programmers to interface with Hewlett-Packard inkjet and LaserJet® printers. LaserJet® is the registered trademark of the Hewlett-Packard Company of Palo Alto, Calif., U.S.A. Similar kits can be developed and implemented for other printers.

Printer-ready data is forwarded to wireless interface 260 via link 239. Wireless interface 260, in accordance with a wireless communication protocol available in the select printer or in a device coupled to the select printer, uses one of a 802.11 module 262, a Bluetooth® module 264, an IR module 266 or other module 268 including current and future communication transports to communicate the printer-ready data via wireless link 280 to printer 275 or some other printer within communication range of the wireless interface 260. Note that printer-ready data can be forwarded to printer 275 via a wireless access point or other communicatively coupled peripheral devices via links other than wireless link 280.

Reference is now directed to the print service command path 240 illustrated in FIG. 2. Print service command path 240 receives the print job request 214 from router 220 via link 225 and information to be printed via link 231. Information to be printed can be the actual information to print as noted above, or a reference to information to print. Print service manager 242 receives the print job request 214 and the information to be printed as defined or otherwise identified by the information identifier(s) 144 via link 231 and transforms the print job request 214 in accordance with the select print service 270 to generate a service compliant job request 245. The service compliant job request 245 includes information that enables the select print service 270 to use printer 275, or other printers communicatively coupled with print service 270, to create a hard copy product. The information can be a file identifier in combination with a directory, an Internet link, or similar mechanism that identifies print service accessible data.

Printers communicatively coupled to print service 270 can be located in physical proximity with mobile device 100 or can be in a remote location, even in a different country, from mobile device 100. For example, a printer (not shown) can be located in a kiosk in a public place such as an airport, a café, a restaurant, etc. Alternatively, a printer can be located within a place of business, or within a user's home. Regardless of the printer's physical location, wireless interface 260 receives the service compliant job request 245 via link 247 and forwards the request to print service 270 via wireless link 282. Wireless link 282 couples print service 270 to print service command path 240 via 802.11 module 262 or future wireless communication protocols suitable for wireless two-way data communication to print service 270.

Print service 270 can include application software, a host of printer specific drivers, multiple interfaces to other communication services, networks, and the like. In addition print service 270 includes print task management logic configured to execute and monitor one or more print tasks identified in the service compliant job request 245. As instructed in the service compliant job request 245, print service 270 accesses, transforms, and/or otherwise renders the information to be printed and communicates printer-ready data via link 272 to printer 275. Link 272 may be a wired or wireless link.

Print service 270 is a collection of logic modules each containing a plurality of executable instructions for performing specific tasks. For example, print service 270 can be configured with a communication interface and printer-ready logic, as well as other specialized interfaces. The communication interface locates, accesses, and downloads information from one or more Internet-coupled servers (not shown). Requests for web accessible information can be received via encoded uniform resource locators (URLs) within the service compliant job request 245. The communication interface forwards the request to the appropriate Internet server. After print service 270 establishes a communication session with the appropriate Internet server, print service 270 pulls the requested information in accordance with HTTP.

HTTP is just one transport protocol of many that can be used to acquire content to print. For example, files can be communicated using File Transfer Protocol (FTP). In these examples, the print service would use HTTP, FTP, or another suitable content transmission protocol to obtain the referenced content/data to be printed. The received file may comprise HTML or XML content. Regardless of content format, the content is received by the printer-ready logic which images, renders, and translates the content for printing on printer 275 as instructed by the received service compliant job request 245.

When the service compliant job request 245 directs the print service 270 to forward information upon completion of a task, upon detection of an error condition, or other printer status information, wireless interface 260 receives the feedback and forwards the status information to the print service manager 242 and user interface 250 via link 257.

In this embodiment, operation of the user interface 250 initiates a seamless integration of printing models that can be applied to any information delivered to and/or addressable by mobile device 100. Information includes a full range of printable material from information rendered on a display associated with the mobile device 100 to word-processing, spreadsheet, and other office applications, as well as high-resolution photographs, web pages, web-accessible coupons, etc. addressable and accessible via one or more networks coupled to print service 270.

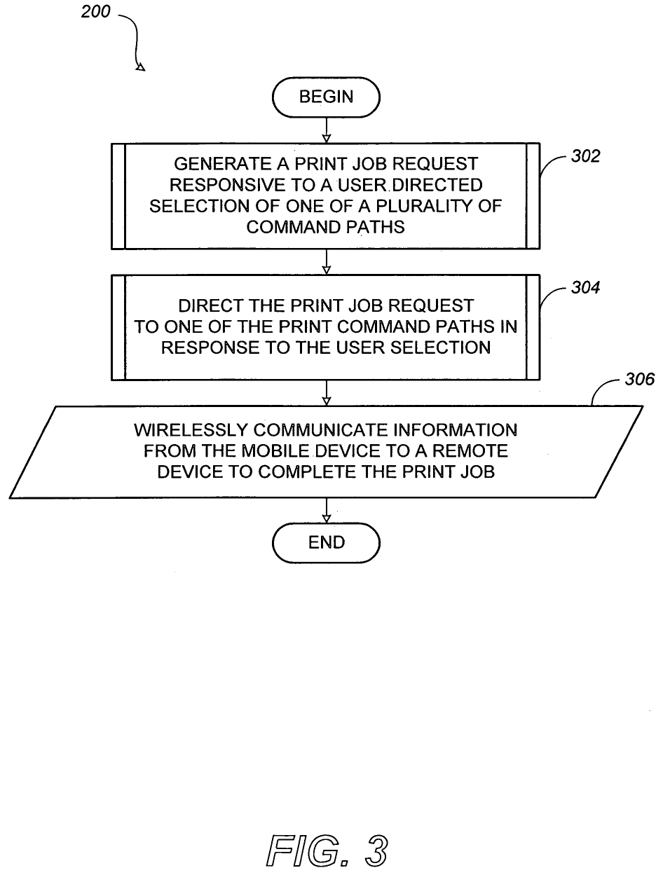

Reference is now directed to FIG. 3, which presents an embodiment of a method for enabling remote printing from a wireless mobile device 100 that can be implemented using the print system 200 of FIGS. 1 and 2. As shown in block 302, the print system 200 generates a print job request responsive to a user directed selection of one of a plurality of command paths. Next, as illustrated in block 304, the print system 200 directs the print job request to one of the print command paths in response to the user selection in block 302. Thereafter, as indicated in block 306, the print system 200 wirelessly communicates information from the mobile device 100 to a remote device to complete the print job. As described above, the remote device can be a printer or a wireless-access point coupled to a printer.

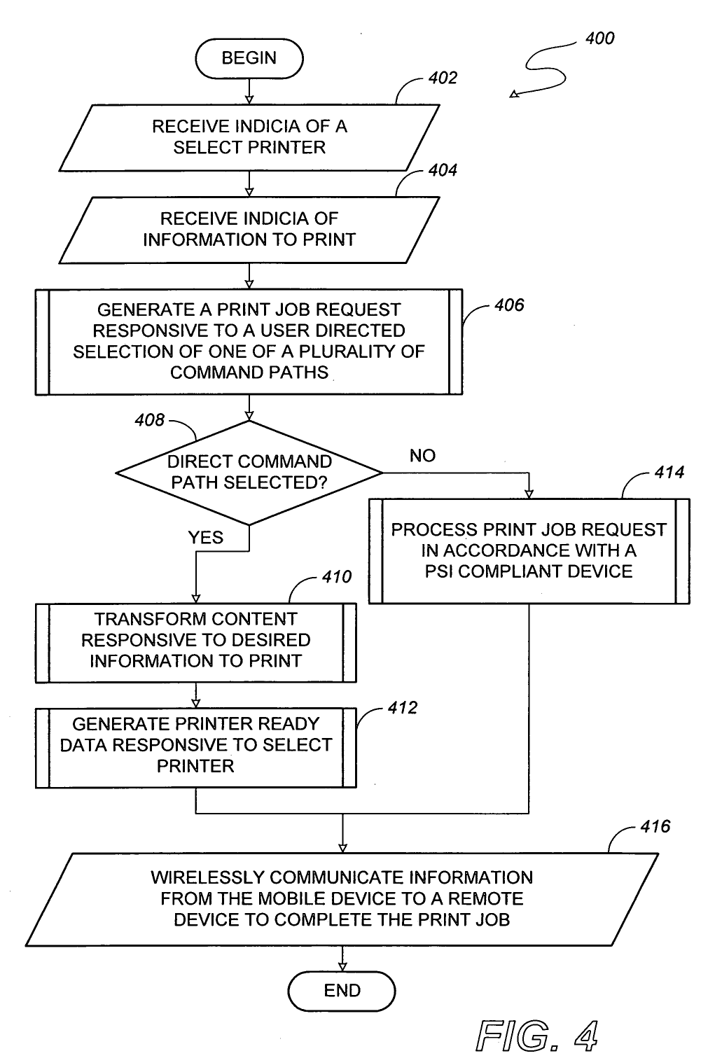

FIG. 4 presents a flow diagram illustrating a more detailed method 400 for enabling remote printing from a wireless mobile device 100 that can be implemented using the print system 200 of FIGS. 1 and 2. As illustrated in input block 402, the print system 200 receives indicia of a select printer that is desired to be used to generate a hard copy product from the mobile device 100. Input block 404 indicates that the print system 200 further receives indicia of information to print. It should be understood that the data received in blocks 402 and 404 can be received in the opposite order of that shown in FIG. 4 or even substantially simultaneously.

Next, as indicated in block 406, print system 200 generates a print job request responsive to a user directed selection of one of a plurality of command paths. Note that the print job request is also responsive to the select printer and the information to print. Thereafter, as illustrated in query 408, the print system 200 determines which command path is desired by the operator of the mobile device 100. When an operator of the mobile device 100 desires to wirelessly communicate directly with a printer local to the mobile device 100, the operator directs the selection of the direct command path as indicated by the flow control arrow labeled “YES” exiting query 408. As indicated in block 410, the print system 200 transforms content responsive to the information that the operator desires to print to an intermediate representation. In the case of processing via the direct command path, this information is locally stored or otherwise available to the mobile device. Thereafter, as illustrated in block 412, print system 200 generates printer ready data responsive to the select printer.

Otherwise, when an operator of the mobile device 100 desires to wirelessly communicate indirectly with a printer via a remote print service, the operator directs the selection of the print service command path, as indicated by the flow control arrow labeled “NO” exiting query 408. Next, as shown in block 414, print system 200 processes the print job request in accordance with the input requirements of a PSI compliant device.

As illustrated in block 416, once the print system 200 has begun to generate printer ready data, as is the case when the direct command path is selected or the print system has generated a print job request recognizable by a select print service, as is the case when the print service command path is selected, the print system 200 wirelessly communicates the printer-ready data or the print job request from the mobile device 100 to a remote device to complete the print job. When the direct command path is chosen, mobile device 100 establishes a wireless communication link to the select printer and forwards printer ready data generated on the mobile device 100 to the printer to generate a hard copy product of the desired content. Otherwise, when the print service command path is chosen, mobile device 100 establishes a wireless communication link and forwards a print job request to a select print service. The print service then manages or otherwise directs the collection and rendering of information as may be required for a select network-coupled printing device.

Any process descriptions or blocks in the flow diagrams presented in FIGS. 3 and 4 should be understood to represent modules, segments, or portions of code or logic, which include one or more executable instructions for implementing specific-logical functions or blocks in the associated process. Alternate implementations are included within the scope of the mobile-device print system 200 and methods for remote printing 300, 400 in which functions may be executed out-of-order from that shown or discussed, including substantially concurrently or in reverse order, depending on the functionality involved, as would be understood by those reasonably skilled in the art.

1. A mobile-device print system, comprising:
a user interface configured to receive indicia of a user directed selection of one of a plurality of print command paths provided by the print system;
a router communicatively coupled to the user interface and configured to forward a print job request to one of a plurality of print job managers responsive to the selection of one of the plurality of print command paths; and
a wireless output interface communicatively coupled to the plurality of print job managers configured to establish a communication link and forward information via the communication link to a remote printing device.

2. The system of claim 1, wherein the user interface is a graphical user interface configured to receive printer attributes associated with a remote printer.

3. The system of claim 2, wherein the printer attributes comprise an address and a model identifier.

4. The system of claim 2, wherein the printer attributes comprise a user friendly location descriptor for the remote printer.

5. The system of claim 1, wherein the print task router forwards the print job request to at least one print manager.

6. The system of claim 5, wherein the print service manager formats the print job request in accordance with a print service interface (PSI) compliant device for job completion.

7. The system of claim 5, wherein the direct print manager processes the print job request by transforming content responsive to information that a user of the system desires to print.

8. The system of claim 5, wherein the direct print manager processes the print job request by creating printer ready data in accordance with the remote printing device.

9. The system of claim 5, wherein the direct print manager processes the print job request by specifying the use of a specific transport protocol.

10. A method for enabling remote printing from a wireless mobile-communication device comprising:
generating a print job request responsive to a user directed selection of one of a plurality of print command paths;
directing the print job request to one of the plurality of print command paths in response to the user directed selection; and
wirelessly communicating information from the mobile-communication device to a remote device to complete the print job.

11. The method of claim 10, wherein generating a print job request comprises receiving indicia of information to print via the remote device.

12. The method of claim 10, wherein generating a print job request comprises receiving indicia of a select printer.

13. The method of claim 10, wherein directing the print job request comprises forwarding the print job request to one of a first path and a second path wherein each of the first and second paths comprises a respective print manager.

14. The method of claim 13, wherein a print service manager processes the print job request in accordance with a print service interface compliant device to complete the print job.

15. The method of claim 13, wherein a direct print manager processes the print job request by transforming content responsive to information that a user of the system desires to print.

16. The method of claim 13, wherein a direct print manager processes the print job request by creating printer ready data in accordance with the remote printing device.

17. The method of claim 13, wherein a direct print manager processes the print job request by specifying the use of a transport protocol.

18. A print system for a wireless mobile-communication device, comprising:
means for receiving a plurality of user directed inputs wherein at least one of the inputs identifies a select print command path for processing a print job request; and
means for routing the print job request responsive to the select print command path, wherein said means for routing accesses a print service manager configured to transform the print job request in accordance with a print service interface.

19. The print system of claim 18, wherein the means for routing the print job request accesses a direct print manager configured to transform source content into an encoded intermediate representation.

20. The print system of claim 19, wherein the encoded intermediate representation comprises color data.

21. The print system of claim 19, further comprising:
means for creating optimized printer specific data responsive to the encoded intermediate representation; and
means for transmitting the optimized printer specific data to a printer.

22. The print system of claim 21, wherein the means for creating optimized printer specific data comprises an appliance printing development kit.

23. The print system of claim 21, wherein the means for transmitting the optimized printer specific data comprises one of a radio-frequency communication medium and an infra-red frequency communication medium.

24. A computer-readable medium having stored thereon an executable instruction set, the instruction set, when executed by a processor, directs the processor to perform a method comprising:
generating a print job request that comprises indicia of a user desired print command path and indicia of information to print, wherein the user desired print command path is selected from a plurality of available print command paths;
forwarding the print job request responsive to the indicia of the user desired print command path; and
wirelessly communicating information from the mobile-communication device to a remote device to complete the print job.

25. The computer-readable medium of claim 24, wherein when the user desired print command path includes a print service manager the method further comprises processing the print job request in accordance with a print service interface compliant device.

26. The computer-readable medium of claim 24, wherein when the user desired print command path includes a direct print manager the method further comprises processing the print job request by transforming information to print responsive to the indicia of information to print.

27. The computer-readable medium of claim 24, wherein when the user desired print command path includes a direct print manager the method further comprises processing the print job request by creating printer ready data in accordance with a remote printing device.

28. The computer-readable medium of claim 24, when the user desired print command path includes a direct print manager the method further comprises processing the print job request by using one of a plurality of transport protocols.
